(19) United States
(12) Patent Application Publication
(10) Pub. No.: US 2016/0131943 A1
(43) Pub. Date: May 12, 2016

(54) LIQUID CRYSTAL DISPLAY DEVICE

(71) Applicant: SHARP KABUSHIKI KAISHA, Osaka (JP)

(72) Inventor: Kazuya MURAKAMI, Osaka (JP)

(73) Assignee: Sharp Kabushiki Kaisha, Osaka (JP)

(21) Appl. No.: 14/895,878

(22) PCT Filed: Feb. 28, 2014
(86) PCT No.: PCT/JP2014/055036

§ 371 Date: Dec. 3, 2015

(30) Foreign Application Priority Data
Jun. 4, 2013 (JP) 2013-117973

(51) Int. Cl. G02F 1/1335; G02F 1/1333

(52) U.S. Cl. CPC G02F 1/133528; G02F 1/13338

(57) ABSTRACT

A liquid crystal display device, including; a liquid crystal panel; a polarizing plate attached to a surface of the liquid crystal panel; an adhesive sheet covering the polarizing plate, the adhesive sheet having a central region attached to the polarizing plate and a peripheral region attached to a peripheral surface of the liquid crystal panel, the peripheral region enclosing an entire circumference of an outer edge of the polarizing plate; and a transmissive member attached to the adhesive sheet.

### TECHNICAL FIELD

The present invention relates to a liquid crystal display device and specifically to a liquid display device having a configuration that inhibits a polarizing plate from turning yellow.

### BACKGROUND ART

Conventionally, a liquid crystal display device that displays an image on a liquid crystal panel is known. In the liquid crystal display device, a polarizing plate is attached to the liquid crystal panel. A protective glass substrate is attached to the polarizing plate. In recent years, a touch panel, instead of the protective glass substrate, is attached to the polarizing plate.

When the liquid crystal display device described above is used in a hot and humid environment, moisture can attach to the polarizing plate. If this moisture causes the polarizing plate to undergo hydrolysis, the polarizing plate turns yellow.

Japanese Patent Application Laid-Open Publication No. 2006-195519 discloses a technology that inhibits a polarizing plate from turning yellow. In the patent document above, an acid acceptor is included in the adhesive agent that bonds triacetyl cellulose film to a polarizing member or the substrate.

### SUMMARY OF THE INVENTION

However, including the acid acceptor in the adhesive agent is not enough to inhibit the polarizing plate from turning yellow.

The aim of the present invention is to provide a liquid crystal display device that can inhibit the polarizing plate from turning yellow.

The liquid crystal display device according to embodiments of the present invention includes: a liquid crystal panel; a polarizing plate; an adhesive sheet; and a transmissive member (also referred to as a transparent plate). The polarizing plate is attached to the liquid crystal panel. The adhesive sheet is attached to the polarizing plate and covers the polarizing plate. The transmissive member is attached to the adhesive sheet. The adhesive sheet includes a central region and a peripheral region. The central region overlaps with the polarizing plate. The peripheral region is attached to the liquid crystal panel and encloses an entire circumference of an outer edge of the polarizing plate.

The liquid crystal display device according to embodiments of the present invention can inhibit the polarizing plate from turning yellow.

### BRIEF DESCRIPTION OF THE DRAWINGS

FIG. 1 is a cross-sectional view showing a schematic configuration of a liquid crystal display device of Embodiment 1 of the present invention.

FIG. 2 is a surface view showing a relationship between a polarizing plate and an adhesive sheet attached to the polarizing plate.

FIG. 3 is a cross-sectional view showing a schematic configuration of a liquid crystal display device of Embodiment 2 of the present invention.

FIG. 4 is a cross-sectional view showing a schematic configuration of a liquid crystal display device of Embodiment 3 of the present invention.

### DETAILED DESCRIPTION OF EMBODIMENTS

The liquid crystal display device according to aspect 1 of the present invention includes: a liquid crystal panel; a polarizing plate; an adhesive sheet; and a transmissive member. The polarizing plate is attached to the liquid crystal panel. The adhesive sheet is attached to the polarizing plate and covers the polarizing plate. The transmissive member is attached to the adhesive sheet. The adhesive sheet includes a central region and a peripheral region. The central region lies on top of the polarizing plate. The peripheral region is attached to the liquid crystal panel and encloses an entire circumference of an outer edge of the polarizing plate.

In the aspect described above, the polarizing plate is enclosed between the adhesive sheet and the liquid crystal panel. This configuration makes moisture that occurs when using the liquid crystal display device in a hot and humid environment less likely to attach to the polarizing plate. As a result, this configuration can inhibit the polarizing plate from turning yellow.

In the aspect described above, the transmissive member may be a protective glass substrate or a touch panel.

In the liquid crystal display device according to aspect 2 of the present invention, the polarizing plate in the liquid crystal display device according to aspect 1 described above includes: a surface; and an inclined face. The adhesive sheet is attached to the surface. The inclined face is inclined with respect to the surface and formed on the outer edge. A portion of the peripheral region is attached to the inclined face.

Compared to a case in which an inclined face is not formed on the outer edge, the aspect described above enables the adhesive sheet to be adhered to the outer edge of the polarizing plate. This configuration makes moisture that occurs when using the liquid crystal display device in a hot and humid environment less likely to attach to the polarizing plate.

In the liquid display device according to aspect 3 of the present invention, the adhesive sheet in the liquid display device according to aspect 1 described above further includes: a first surface; a second surface; and a recess. The first surface is attached to the transmissive member. The second surface is located on an opposite side of the first surface in a thickness direction of the adhesive sheet and is parallel to the first surface. The recess has an opening in the second surface. The recess houses the polarizing plate therein. A portion of the adhesive sheet that is located at a periphery of the recess is the peripheral region.

Compared to a case in which a recess is not formed, the aspect described above makes it easy to secure an area in the liquid crystal panel to which the peripheral region can be attached.

Specific embodiments of the present invention will be explained below with reference to figures. Portions in the drawings that are the same or similar are assigned the same reference characters and descriptions thereof will not be repeated.

### Embodiment 1

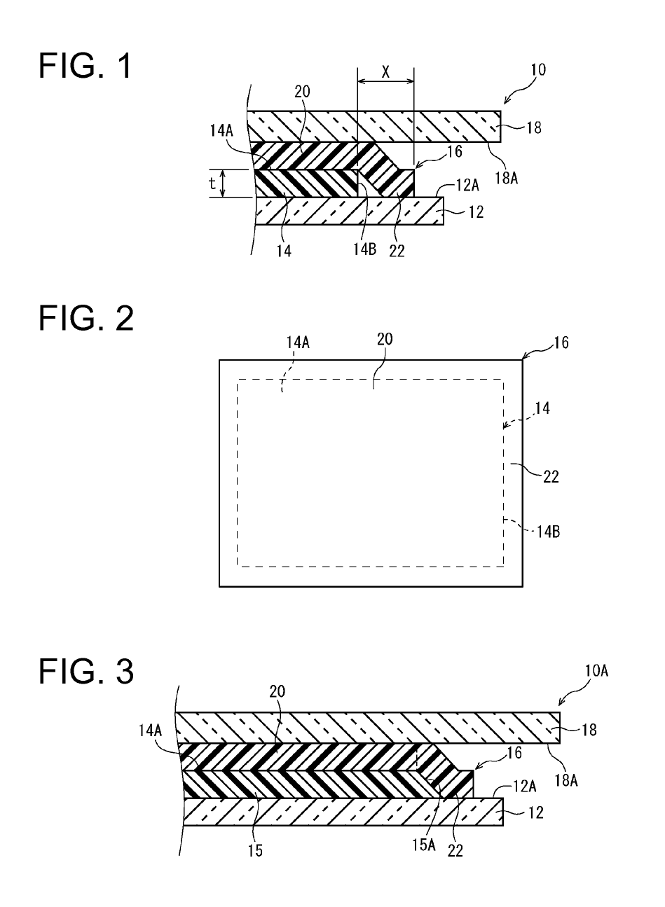

FIG. 1 is a cross-sectional view showing a schematic configuration of a liquid crystal display device 10 according to Embodiment 1 of the present invention. The liquid crystal display device 10 is used to display an image on mobile devices such as smartphones or tablets, for example. The liquid crystal display device 10 includes a liquid crystal panel 12, a polarizing plate 14, an adhesive sheet 16, and a transparent medium 18.

The liquid crystal panel 12 includes a display region formed by a plurality of pixels. The display region displays an image. The liquid crystal panel 12 includes an active matrix substrate, an opposite substrate, and a liquid crystal layer enclosed therebetween.

Of the light that passes through the liquid crystal panel 12, the polarizing plate 14 allows only the light that is oscillating in a specific direction to pass through the liquid crystal panel. The polarizing plate 14 is attached to a surface 12A of the liquid crystal panel 12, which is on the side of the observer.

The adhesive sheet 16 is attached to a surface 14A of the polarizing plate 14, which is on the side of the observer. The adhesive sheet 16 covers all of the surface 14A. The adhesive sheet 16 has a uniform thickness. The adhesive sheet 16 is transparent. It is preferable that the transmittance of the adhesive sheet 16 be at least 95%. It is preferable that the thickness of the adhesive sheet 16 be 50 to 200 μm. It is preferable that the refractive index of the adhesive sheet 16 be 1.4 to 1.6. Here, the transmittance of the adhesive sheet 16 is defined as the proportion of the amount of light that passed through the adhesive sheet 16 relative to the amount of light that entered the adhesive sheet 16. The refractive index of the adhesive sheet 16 is defined by JIS K7142 (Plastics-Determination of Refractive Index according to the Japan Industrial Standards (JIS)).

The transmissive member 18 may be a protective glass substrate for protecting the liquid crystal panel 12 or a touch panel. A surface 18A of the transmissive member 18, which is on the side of the liquid crystal panel 12, is bonded to the adhesive sheet 16. The transmissive member 18 is attached to the adhesive sheet 16 after the adhesive sheet 16 is attached to the polarizing plate 14.

Here, the adhesive sheet 16 is attached not only to the polarizing plate 14 but also to the liquid crystal panel 12. This point is described with reference to FIG. 2. FIG. 2 is a surface view showing a relationship between the polarizing plate 14 and the adhesive sheet 16 attached to the polarizing plate 14.

When being attached to the polarizing plate 14, the adhesive sheet 16 includes a region that lies on top of the polarizing plate 14 (referred to as a central region 20 below) and a region that is on the outer side of the polarizing plate 14, or in other words the region that does not overlap the polarizing plate 14 (referred to a peripheral region 22 below). The central region 20 is attached to the surface 14A and covers all of the surface 14A. The peripheral region 22 is attached to the surface 12A and encloses the entire circumference of the outer edge of the polarizing plate 14 (specifically, the end face 14B of the polarizing plate 14). As shown in FIG. 1, to attach the peripheral region 22 to the surface 12A in a stable manner, the width X of the peripheral region 22 may be at least twice the thickness t of the polarizing plate 14. A gap may or may not be formed between the peripheral region 22 and the end face 14B. In the present embodiment, a gap is formed between the peripheral region 22 and the end face 14B, as shown in FIG. 1.

In the liquid crystal display device 10, of the adhesive sheet 16, the peripheral region 22 attached to the liquid crystal panel 12 encloses the entire circumference of the outer edge of the polarizing plate 14 (specifically the end face 14B). In short, the polarizing plate 14 is enclosed between the adhesive sheet 16 and the liquid crystal panel 12. This configuration prevents moisture that occurs when using the liquid crystal panel 10 in a hot and humid environment, specifically the moisture that occurs in the space on the outer side of the adhesive sheet 16, which is a part of the space formed between the transmissive member 18 and the liquid crystal panel 12, from entering into the inner side of the adhesive sheet 16 and attaching to the polarizing plate 14. As a result, this configuration can inhibit the polarizing plate 14 from turning yellow.

### Embodiment 2

A liquid crystal display device 10A according to Embodiment 2 of the present invention is described with reference to FIG. 3. Compared to the liquid crystal display device 10, the liquid crystal display device 10A has a different polarizing plate. Compared to the polarizing plate 14 according to Embodiment 1, the polarizing plate 15 of the present embodiment has an end face 14B that is inclined with respect to a surface 14A. In short, an inclined surface is formed on the outer edge of the polarizing plate 15. Below, the end face 14B is referred to as an inclined face 15.

The inclined face 15 is formed on the entire periphery of the polarizing plate 14. The angle of the incline of the inclined face 15 with respect to the surface 14A is arbitrary. The inclined face 15 connects to the surface 14A. The inclined face 15 connects to the surface 12A of the liquid crystal panel 12. The inclined face 15 does not need to connect to the surface 12A. In other words, the inclined face formed on the outer edge of the polarizing plate 14 does not need to be the very end face of the polarizing plate 14.

In the liquid crystal display device 10A, the peripheral region 22 is attached not only to the surface 12A but also to the inclined face 16A. This configuration makes it less likely for a gap to be formed between the adhesive sheet 16 and the polarizing plate 14 and between the adhesive sheet 16 and the liquid crystal panel 12. In short, the adhesion of the adhesive sheet 16 to the liquid crystal panel 12 improves. As a result, even when the liquid crystal display device 10A is used in a hot and humid environment, this configuration makes it less likely for moisture to occur between the adhesive sheet 16 and the polarizing plate 14 and between the adhesive sheet 16 and the liquid crystal panel 12. In other words, condensation becomes less likely to occur. Thus, the liquid crystal display device 10A can further prevent the polarizing plate 14 from turning yellow.

### Embodiment 3

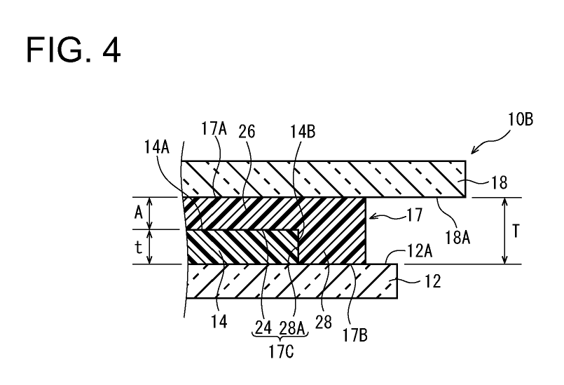

A liquid crystal display device 10B according to Embodiment 3 of the present invention is described with reference to FIG. 4. Compared to the liquid crystal display device 10, the liquid crystal display device 10B has a different adhesive sheet. The adhesive sheet 17 according to the present embodiment includes a surface 17A, a surface 17B, and a recess 17C.

The surface 17B is located closer to the liquid crystal panel 12 than the surface 17A. The surface 17B is parallel to the surface 17A. The surface 17B does not need to be strictly parallel to the surface 17A.

The recess 17C is an opening located in the middle of the surface 17B. In this configuration, a side face 28A and a bonding surface 24 are formed in the recess 17C. The side face 28A is formed on the entire periphery. The bonding surface 24 is connected to the side face 28A and is parallel to the surface 17A.

The polarizing plate 14 is housed in the recess 17C. When the polarizing plate 14 is housed in the recess, a surface 14A of the polarizing plate 14 is attached to the bonding surface 24. An end face 14B of the polarizing plate 14 touches the side face 28A. The end face 14B does not need to touch the side face 28A.

A portion of the adhesive sheet 17 that surrounds the recess 17C in a plan view is attached to the liquid crystal panel 12.

In short, the adhesive sheet 17 includes, in a plan view, a region that lies on top of the polarizing plate 14 (referred to as a central region 26 below) and a region that is arranged on the peripheral region of the polarizing plate 14 (referred to as a peripheral region 28). In other words, of the adhesive sheet 17, the region that lies on top of the recess 17C in the plan view is the central region 26, and the region that is located on the peripheral region of the recess 17C in the plan view is the peripheral region 28. In short, the adhesive sheet 17 is a compact, in which the peripheral region 28 thereof is thicker than the central region 26 thereof. The adhesive sheet 17 is formed by injection molding or the like, for example.

It is preferable that a thickness T of the peripheral region 28 satisfy the following formula (1) when the thickness of the central region 26 is defined as A, and the thickness of the polarizing plate 14 as t:

A+1.1×t≧T≧A+t (1)

When T<A+t, it becomes difficult to ensure adhesion between the peripheral region 28 and the liquid crystal panel 12. When T>A+1.1×t, it becomes difficult to ensure adhesion between the central region 26 and a transmissive member 18. Thus, it is preferable that the thickness T satisfy formula (1).

In the example shown in FIG. 4, the transmissive member 18 may be attached to the adhesive sheet 17 after the adhesive sheet 17 is attached to the polarizing plate 14, or the adhesive sheet 17 may be attached to the polarizing plate 14 after the adhesive sheet 17 is attached to the transmissive member 18.

In the liquid crystal display device 10B, it is easy to secure an area on the peripheral region 28 that touches the liquid crystal panel 12. This configuration makes it less likely for moisture that occurs in the space on the outer side of the adhesive sheet 17 when using the liquid crystal display device 10B in a hot and humid environment to enter the inner side of the adhesive sheet 17. As a result, this configuration can inhibit the polarizing plate 14 from turning yellow.

An inner periphery 22A touches the side face 14B of the polarizing plate 14. This configuration makes it less likely for a gap to be formed between the adhesive sheet 17 and the polarizing plate 14 and between the adhesive sheet 17 and the liquid crystal panel 12. As a result, even when the liquid crystal display device 10B is used in a hot and humid environment, this configuration makes it less likely for moisture to occur between the adhesive sheet 17 and the polarizing plate 14 and between the adhesive sheet 17 and the liquid crystal panel 12. In other words, condensation becomes less likely to occur. Thus, the liquid crystal display device 10B can further prevent the polarizing plate 14 from turning yellow.

The embodiments of the present invention have been described above. However, these are merely examples, and the present invention is not at all limited by the embodiments described above.

1. A liquid crystal display device, comprising:
a liquid crystal panel;
a polarizing plate attached to a surface of said liquid crystal panel;
an adhesive sheet covering the polarizing plate, said adhesive sheet having a central region attached to said polarizing plate and a peripheral region attached to a peripheral surface of said liquid crystal panel, said peripheral region enclosing an entire circumference of an outer edge of said polarizing plate; and
a transmissive member attached to said adhesive sheet.

2. The liquid crystal display device according to claim 1, wherein said polarizing plate has:
a surface to which said adhesive sheet is attached; and
an inclined face formed on said outer edge and inclined with respect to said surface,
wherein a portion of said peripheral region of said adhesive sheet is attached to said inclined face.

3. The liquid crystal display device according to claim 1, wherein said adhesive sheet further has:
a first surface attached to said transmissive member;
a second surface located on an opposite side of said first surface of said adhesive sheet, said second surface being parallel to said first surface; and
a recess provided in said second surface to house said polarizing plate therein,
wherein a portion of said adhesive sheet that corresponds to a periphery of said recess is said peripheral region.

4. The liquid crystal display device according to claim 1, wherein said transmissive member is a protective glass substrate.

5. The liquid crystal display device according to claim 1, wherein said transmissive member is a touch panel.

6. The liquid crystal display device according to claim 2, wherein said transmissive member is a protective glass substrate.

7. The liquid crystal display device according to claim 3, wherein said transmissive member is a protective glass substrate.

8. The liquid crystal display device according to claim 2, wherein said transmissive member is a touch panel.

9. The liquid crystal display device according to claim 3, wherein said transmissive member is a touch panel.
